(19) United States
(12) Patent Application Publication
(10) Pub. No.: US 2017/0169192 A1
(43) Pub. Date: Jun. 15, 2017

(54) INSERTING STRUCTURED CONTENT IN ITEMIZED REPORTS

(71) Applicant: KONINKLIJKE PHILIPS N.V., EINDHOVEN (NL)

(72) Inventors: MERLIJN SEVENSTER, CHICAGO, IL (US); THUSITHA DANANJAYA DE SILVA MABOTUWANA, BOTHELL, WA (US); ERIC COHEN-SOLAL, OSSINING, NY (US)

(21) Appl. No.: 15/118,159

(22) PCT Filed: Feb. 5, 2015
(86) PCT No.: PCT/IB2015/050864

§ 371 Date: Aug. 11, 2016

Related U.S. Application Data
(60) Provisional application No. 61/942,052, filed on Feb. 20, 2014.

(51) Int. Cl. G06F 19/00; G06F 17/30

(52) U.S. Cl. CPC G06F 19/3487; G06F 19/322; G06F 19/324; G06F 19/3481; G06F 19/3443; G06F 17/3005

(57) ABSTRACT

The present application relates to a system and method for inserting structured content into template-based documents including retrieving one or more information objects queried from a database, detecting one or more paragraph identifiers in a document, mapping the one or more information objects to the detected one or more paragraph identifiers, automatically inserting the mapped information objects into the paragraph identifiers, and displaying the document with the one or more information objects inserted into the detected one or more paragraph identifiers.

The present application relates generally to a system and method for inserting structured content in itemized reports. It finds particular application in conjunction with the insertion of structured content seamlessly into itemized or template based documents and will be described with particular reference thereto. However, it is to be understood that it also finds application in other usage scenarios and is not necessarily limited to the aforementioned application.

On a routine basis, clinical research associates (CRAs), also known as cancer registrars, and nurses are tasked with maintaining longitudinal records of cancer measurements of patients participating in clinical trials. Lesion tracking software allows for storing structured measurement data. This data can be rendered as free text and inserted in the radiology report as a dedicated measurement section. The lesion tracking software allows the radiologist to build up a longitudinal record of a patient's measured findings. Whenever a new exam is made for the patient, the radiologist can extend the record with the latest measurements. Although the lesion tracking software is meant primarily for registering quantitative data (measurements) it can also be used to store qualitative assessments (“stable”, “decreased in size”).

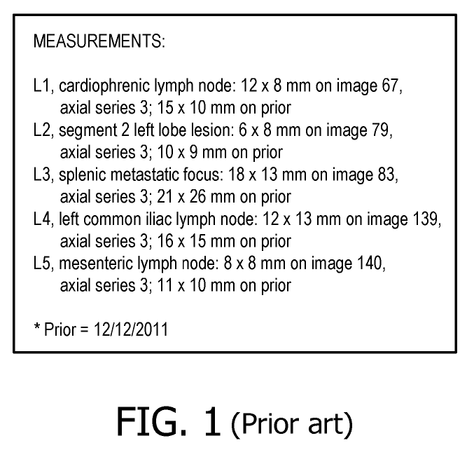

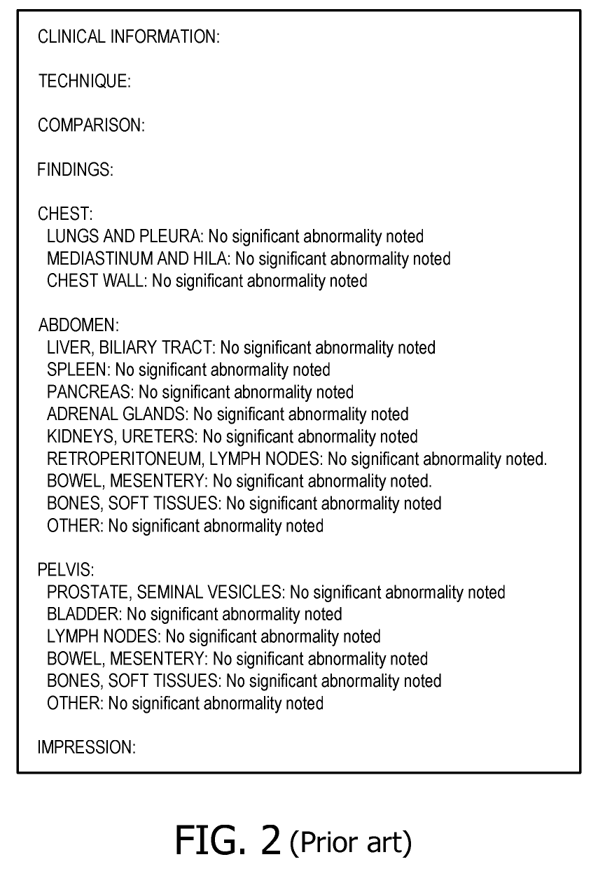

For example, as shown in FIG. 1, the content recorded in the lesion tracking software can be rendered as a free-text section which can be copied to a word processing environment and pasted into a final radiology report. However, this process is found to be very time consuming. There is also a trend in radiology to adopt itemized reporting styles, that is, to adopt report templates that organize the discussion of the clinical exam by organ as shown in FIG. 2. The radiologist can type or dictate directly into the reporting environment, create his/her own templates, use templates created by their institution (i.e., institution-specific templates) or use from-the-shelf templates. However, this process deteriorates the quality of radiology reports as finding-specific content is spread across multiple report sections. Specifically, the consumer of the report would have to navigate between the free-text description of a finding on the one hand and its measurements on the other hand, which are now spread across multiple sections. In addition, the labels that are used to describe findings in the lesion tracking software are less informative if the findings are separated from the narrative description. For instance, the label “segment 2 left lobe lesion” refers to the liver, but this may not be clear to healthcare professionals consuming the report.

The present application provides new and improved methods and system which overcome the above-referenced problems and others.

In accordance with one aspect, a method for inserting structured content into template-based documents is provided. The method includes retrieving one or more information objects queried from a database, detecting one or more paragraph identifiers in a document, mapping the one or more information objects to the detected one or more paragraph identifiers, automatically inserting the mapped information objects into the paragraph identifiers, and displaying the document with the one or more information objects inserted into the detected one or more paragraph identifiers.

In accordance with another aspect, a system for inserting structured content into template-based documents is provided. The system includes a finding database which stores one or more clinical findings. A mapping device which includes a display which displays an interface and one or more processors programmed to retrieve one or more clinical findings queried from the finding database, detect one or more paragraph identifiers in a document, map the one or more clinical findings to the detected one or more paragraph identifiers, automatically insert the mapped clinical findings into the paragraph identifiers, and displaying the document with the one or clinical findings inserted into the detected one or more paragraph identifiers.

In accordance with another aspect, a system for inserting structured content into template-based documents is provided. The system includes a finding database which stores one or more clinical findings. A mapping device which includes a reporting environment engine configured to retrieve one or more clinical findings queried from the finding database and detect one or more paragraph identifiers in a document. A personalized finding-to-paragraph mapping engine configured to map the one or more clinical findings to the detected one or more paragraph identifiers, automatically insert the mapped clinical findings into the paragraph identifiers; and displaying the document with the one or clinical findings inserted into the detected one or more paragraph identifiers.

One advantage resides in the automated insertion of structured content into itemized or template based documents.

Another advantage resides in the error free insertion of lesion measurements and descriptions into radiology reports.

Another advantage resides in providing a more efficient mechanism to insert lesion measurements and descriptions into radiology reports.

Another advantage resides in increased workflow efficiency.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

FIG. 1 illustrates an exemplary free-text section of a lesion tracking interface according to aspects of the present application.

FIG. 2 illustrates an exemplary itemized section of a lesion tracking interface according to aspects of the present application.

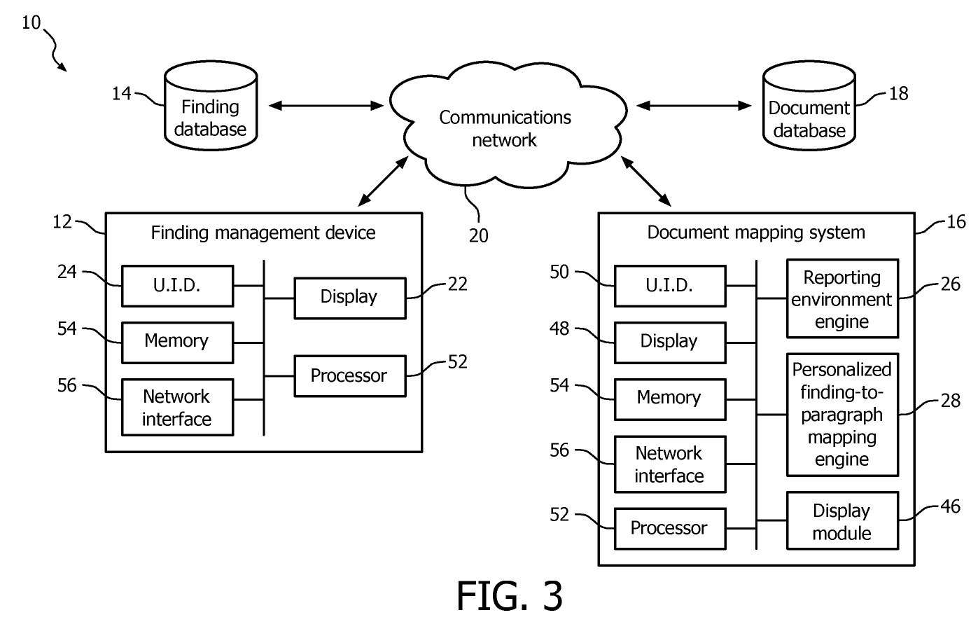

FIG. 3 illustrates a block diagram of an exemplary embodiment of an IT infrastructure according to aspects of the present application.

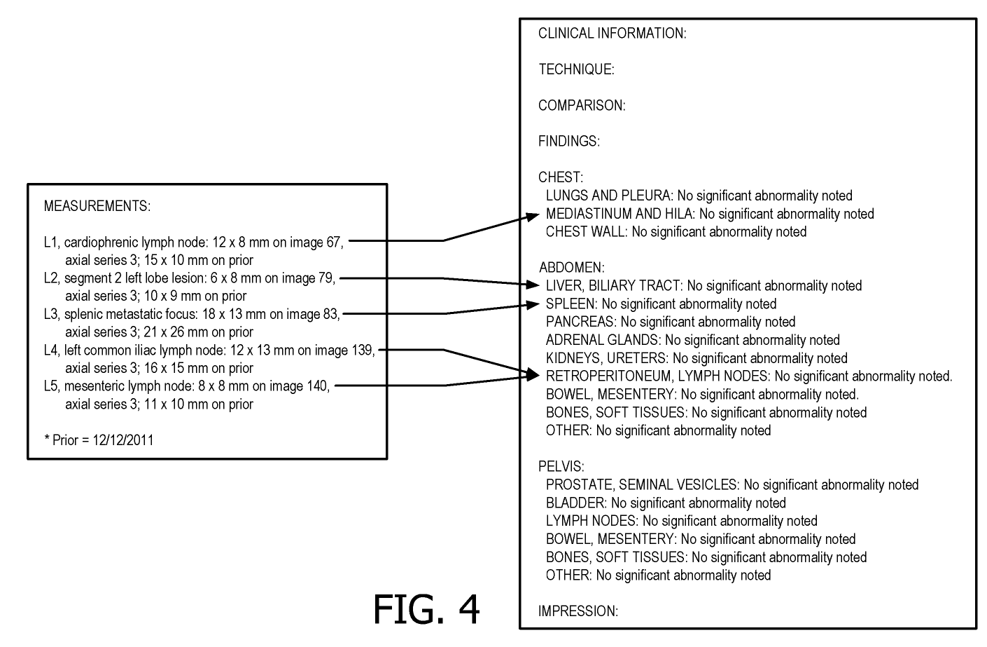

FIG. 4 illustrates a flowchart diagram of insertion of structured content into an itemized or template-based document according to aspects of the present application.

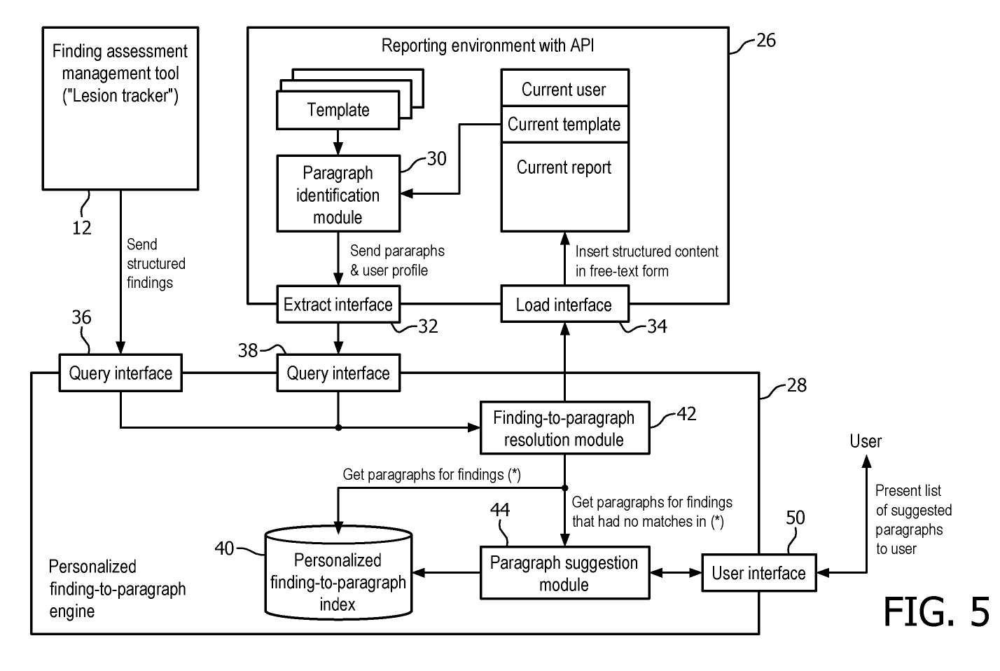

FIG. 5 illustrates a block diagram of an exemplary embodiment of a finding management device and a document mapping system according to aspects of the present application.

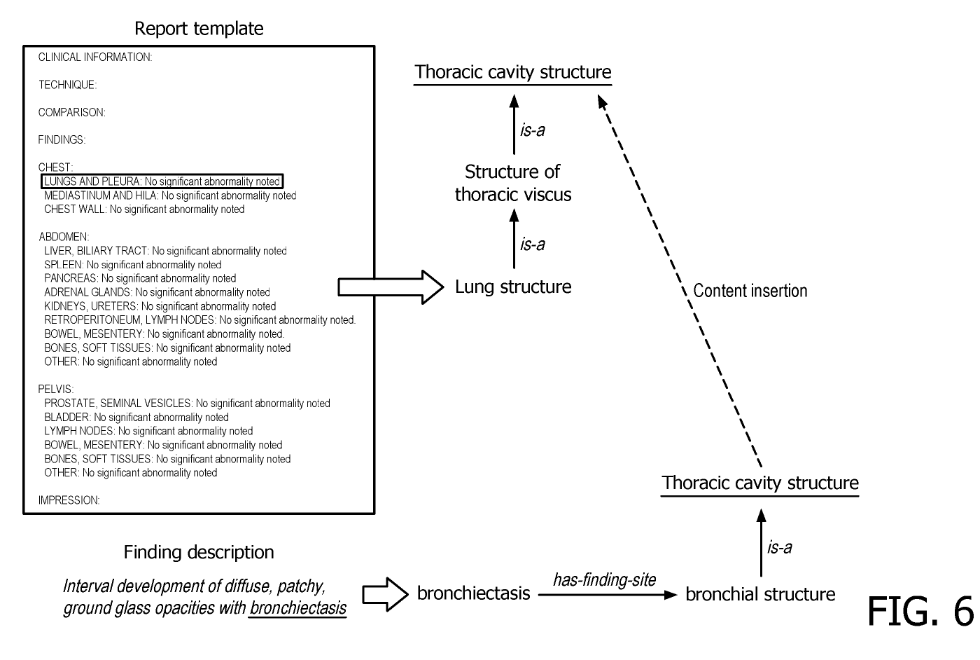

FIG. 6 illustrates a flowchart diagram for using medical ontology for generating mapping suggestions according to aspects of the present application.

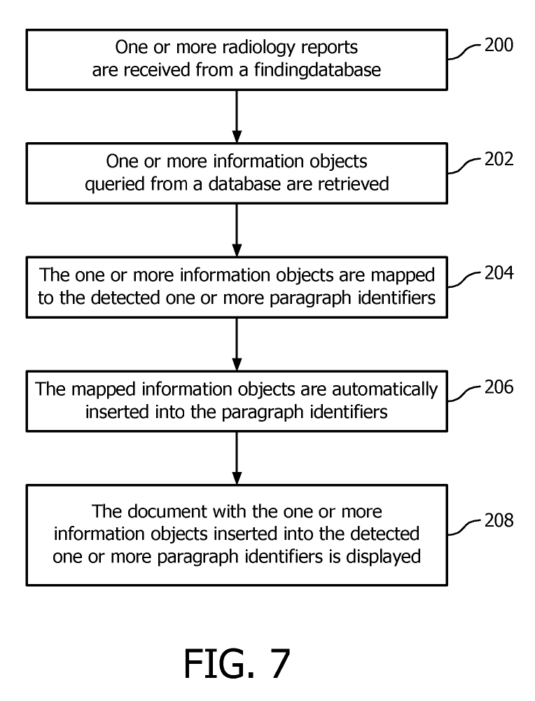

FIG. 7 illustrates a flowchart diagram of a method for inserting structured content in itemized or template-based documents according to aspects of the present application.

With reference to FIG. 3, a block diagram illustrates one embodiment of a IT infrastructure 10 which automatically inserts structured content seamlessly into itemized or template-based documents. The IT infrastructure 10 suitable includes a finding management device 12, a finding database 14, a document mapping system 16, a document database 18, and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The finding management device 12 captures and queries the different descriptors characterizing each individual finding of a patient. Specifically, the finding management device 12 provides an organized way of viewing a patient's findings and corresponding information. For example, the finding management device 12 provides an organized way of viewing lesions and their corresponding lesion information, e.g. longitudinal measurement, description, and the like. The finding management device 12 also releases the findings and corresponding information for a given patient. For example, for a patient identifier (e.g., medical record number), the finding management device 12 provides a list of data objects relating to the findings for that particular patient identifier, each of which includes the following finding information (or a subset thereof): an internal identifier (e.g., HWQIW8), a descriptive label (e.g., segment 2 left lobe lesion), a list of current exam-specific information, and the like. The finding management device 12 also organizes and provides exam information for a patient. For each exam, the following exam information is maintained: a date of exam, a size of measurement(s) (e.g., 12.1×15.3 mm), an image and series on which measurement(s) is/are made (e.g., image 56, series 3), and the like. For example, the finding management device 12 maintains a longitudinal record for each finding and exam relating to a patient. The finding management device 12 also automatically enters in new findings and exams correspond to a patient with without any user interaction.

The one or more findings, corresponding finding information, and exam information are typically stored as finding data within the finding database 14 which is accessed by the finding management device 12 through the communication network 20. As described above, the finding information is stored as finding data and includes an internal identifier, a descriptive label, a list of current exam-specific information, and the like. Likewise, exam information is also typically stored within the finding database 16. The exam information is also stored as finding data and includes a date of exam, a size of measurement(s), an image and series on which measurement(s) is/are made, and the like. The finding and/or exam information can be generated manually and/or automatically. As to the former, a display 22 of the finding management device 12 in conjunction with one or more input devices 24 enable a user to enter finding and/or exam information presented on the display 22. As to the latter, finding and/or exam information is automatically generated and routed without user intervention. For example, the finding management device 12 automatically enters finding data about a lesion measured by the user.

The document mapping system 16 automatically inserts structured finding data received from the finding management device 12 into one or more itemized or template-based documents stored in the document database 18. As shown in FIG. 4, the document mapping system 16 maps finding data received from the finding management device into one or more itemized or template-based documents. For example, the document mapping system 16 maps patient specific finding data relating to one or more findings to specific sections of one or more itemized or template-based documents. Specifically, the document mapping system 16 includes a reporting environment engine 26 which detects paragraph identifiers in a current template of one or more documents and presents a string of text or multi-modal information objects (e.g., hyperlink or image) from the finding database for automatic insertion in the current template under the specified paragraph identifier. The document mapping system 16 also includes a personalized finding-to-paragraph mapping engine 28 that assigns a paragraph identifier to each finding. This is accomplished by utilizing different types of data to map to one paragraph identifier or, at least, to a minimal list of suggested identifiers. It should also be appreciated that the document mapping system 16 inserts the structured finding data in free-text form into itemized or template-based documents without presuming a fixed document template is in place.

With reference to FIGS. 3 and 5, the reporting environment engine 26 includes a paragraph identification module 30 which identifies which paragraphs are present in which template-based documents stored in the document database 18. Specifically, the paragraph identification module 30 represent a paragraph as an identifier, which can be mapped onto its free-text rendering (e.g. “LIVER, BILIARY TRACT”). Further, the paragraph identification module 30 may associate a template with an (ordered) list of paragraph identifiers or anatomical concepts in an ontology (e.g. SNOMED CT or Radlex). The reporting environment engine 24 also includes a paragraph identifier extraction module 32 which is queried for the current reporting template. When queried, the paragraph identifier extraction module 32 sends back a list of paragraph identifiers parameterized by the user's credentials (e.g., “ddoe” for D. Doe, MD) possibly augmented by profile information (“3^{rd} year resident”) and/or group profile (e.g. “Abdomen radiologist”). The reporting environment engine 26 also includes an insertion module 34 which presents the reporting environment as a data structure in which paragraph identifiers are mapped to free-text strings or multi-modal information objects of the finding data. The data structure can be enhanced with variables such as “insert at top” or “insert at bottom”. The reporting environment has the capability to insert the presented finding data in the designated paragraph. It should be appreciated that the reporting environment engine 26 is a software solution that has some or all capabilities currently known to reporting environments, including dictation technology and the ability to switch focus from one paragraph field to another.

The personalized finding-to-paragraph mapping engine 28 includes a finding querying module 36 which queries each individual finding for a given patient maintained by the finding management device 12. The personalized finding-to-paragraph mapping engine 26 also includes a template querying module 38 which queries the reporting environment engine 26 for its current document template and user profile. A personalized finding-to-paragraph index 40 of the personalized finding-to-paragraph mapping engine 28 includes a data structure (e.g., a look-up table) in which a finding identifier (e.g., HWQIW8) and user profile is mapped to a paragraph identifier. The personalized finding-to-paragraph mapping engine 28 also includes a finding-to-paragraph mapping engine 42 which applies every finding data object in the list to the personalized finding-to-paragraph index 40 for a given output of the finding management device 12, parameterized by the user's profile. If the index returns a paragraph identifier, the finding-to-paragraph mapping engine 42 proceeds to the next finding object. If the index does not return a paragraph identifier, a list of all paragraph identifiers (appropriately rendered in free text for human consumption) is presented to the user so that the user can select the appropriate paragraph header. In this last case, providing the user with the entire list of paragraph identifiers can be workflow-inefficient.

The personalized finding-to-paragraph mapping engine 28 also includes a paragraph suggestion module 44 which provides a list of suggested paragraph identifiers. In one embodiment, the paragraph suggestion module 44 utilizes the user profiles to suggest paragraph identifiers. Specifically, the paragraph suggestion module 44 re-queries the index with the same finding identifier by all other user profiles. This provides a larger list of paragraph identifiers (than user-specific identifiers). The paragraph suggestion module 44 removes from the list all paragraph identifiers of paragraphs that are not used by the user. For instance, the user may be using the paragraph “LIVER AND BILIARY TRACT” instead of “LIVER”.

In another embodiment, the paragraph suggestion module 44 utilizes a medical ontology for mapping suggestions of paragraph identifiers. Specifically, the paragraph suggestion module 44 provides a concept-based representation of paragraph headers and allows matching between concepts. Concepts can be extracted from narrative text using concept extraction techniques (e.g., MetaMap is a state of the art module to extract Unified Medical Language System concepts). The ontology contains a large set of relationships which provide useful information on how pieces of information are related. In some embodiments, the user description of a finding does not explicitly describe the location of the finding and the ontology is used to match the finding with the right paragraph identifier by using knowledge about finding location in the body (anatomical location). For example, the descriptive label could be as follows: “Interval development of diffuse, patchy, ground glass opacities with bronchiectasis. No lobar predominance. Bilateral small pleural effusions.” The concept “bronchiectasis” has been extracted and relates in the ontology (e.g. SNOMED-CT) to the anatomical site “Bronchial structure” (via the ‘has-finding-site’ relationship), which itself relates to the parent concept “Thoracic cavity structure” (via ‘is-a’ relationship). On the other hand, each paragraph identifier is represented by a set of extracted concepts. For example, with reference to FIG. 6 a flowchart diagram for using medical ontology for generating mapping suggestions is illustrated. In particular, “Lungs and pleura” section relates to the concept “Lung structure” which itself relates to the parent concept “Structure of thoracic viscus” (is-a relationship), which itself relates to the same concept “Thoracic cavity structure” (is-a relationship) and the match with the concept “bronchiectasis” can be established. As a more general approach, each finding and each paragraph identifier can be represented by their initial set of extracted concepts which can be enriched by adding in anatomical location related concepts (i.e., using the ‘has-finding-site’ relationship) along with their anatomical ancestor concepts (is-a relationship, as shown in the previous example). The ontology module will then match through this mechanism a specific finding to the right paragraph identifier.

In another embodiment, the paragraph suggestion module 44 utilizes patient study information to map suggestions of paragraph identifiers. It is still possible in some instances to get to problematic cases: i) No matching is proposed, and ii) multiple matchings are found after using the previously mentioned techniques. The use of additional patient study information can assist to find a match in case (i) or to disambiguate multiple matchings in case (ii). This additional patient study information can be the reason for exam (e.g. “rule out liver mass”) or the study and series description (e.g. study CT Neck Larynx/Hypopharynx). In both cases, anatomical information can help suggest which paragraph identifier is the most likely candidate to insert the finding description.

In another embodiment, the paragraph suggestion module 44 utilizes automatic organ labeling to map suggestions of paragraph identifiers. The paragraph suggestion module 44 segments the exam based on pixel and contextual information (slice number, series number) and gives one or more organs in which the finding's measurements are (likely to be) made. The paragraph suggestion module 44 can also incorporate image segmentation techniques, but in one implementation it only relies on a table in which the current slice is mapped to a set of organs. It can assumed that the organs detected by the paragraph suggestion module 44 have been annotated with concepts (organ labelling), allowing for comparison with the concepts of the paragraph headers. Moreover, eye gaze technology can be utilized to inform on the anatomical locations that were visited with the most attention, measured by the dwelling time spent on the location as well as specific eye gaze patterns. All the mentioned techniques can be used in serial order or in parallel to suggest the best match between a given finding and a paragraph descriptor.

The document mapping system 16 also includes a display engine 46 which displays the list of suggest paragraph identifiers and/or displays the itemized or template-based documents with the finding data automatically inserted. A display 48 of the document mapping system 16 in conjunction with one or more input device 50 enable a user to select suggest paragraph identifiers presented on the display 50.

While the finding management device 12, document mapping system 16, the reporting environment engine 26, and the personalized finding-to-paragraph mapping engine 28 were shown as independent components, it is to be appreciated that each of the components can be part of an integrated document mapping device 16. At least some of the components of the lesion management system 10 each include at least one processor 52 executing computer executable instructions from at least one memory 54 thereof. Components include the finding management device 12, document mapping system 16, the reporting environment engine 26, and the personalized finding-to-paragraph mapping engine 28. The computer executable instructions embody the functionality of the components and include the applications of the finding management device 12, document mapping system 16, the reporting environment engine 26, and the personalized finding-to-paragraph mapping engine 28. Further, at least some of the components each include a communication unit 56 and/or at least one system bus. A communications unit provides a corresponding processor with an interface to at least one communication network, such as the communication network 18. A system bus allows the exchange of data between sub-components of the components. Sub-components include processors, memories, sensors, display devices, communication units, and so on.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a user input device includes one or more of a mouse, a keyboard, a touch screen display, one or more buttons, one or more switches, one or more toggles, and the like; a database includes one or more memories; and a display device includes one or more of a LCD display, an LED display, a plasma display, a projection display, a touch screen display, and the like, including 3D-capable versions of these.

FIG. 7 illustrates a flowchart diagram of a method for inserting structured content into itemized or template based documents. In a step 200, one or more information objects queried from a finding database are retrieved. In a step 202, one or more paragraph identifiers in a document are detected. In a step 204, the one or more information objects are mapped to the detected one or more paragraph identifiers. In a step 206, the mapped information objects are automatically inserted into the paragraph identifiers. In a step 208, the document with the one or more information objects inserted into the detected one or more paragraph identifiers are displayed.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A method for inserting structured content into template-based documents, the method comprising:
retrieving one or more information objects queried from a database;
detecting one or more paragraph identifiers in a document;
mapping the one or more information objects to the detected one or more paragraph identifiers;
automatically inserting the mapped information objects into the paragraph identifiers; and
displaying the document with the one or more information objects inserted into the detected one or more paragraph identifiers.

2. The method according to claim 1, wherein the information objects are descriptors characterizing individual clinical findings of a patient.

3. The method according to claim 1, wherein the information objects are free-text strings or multi-modal information objects.

4. The method according to claim 1, wherein the one or more paragraph identifiers are parameterized by a user's credentials and/or a group profile.

5. The method according to claim 1, further including:
displaying a list of paragraph identifiers for unmapped information objects to the user.

6. The method according to claim 1, wherein the one or more information objects to the detected one or more paragraph identifiers utilizing at least one of: the user profile, medical ontology, patient study information, and automatic organ labeling.

7. A system comprising:
a display for displaying an interface; and
one or more processors programmed to perform the method of claim 1.

8. A system for inserting structured content into template-based documents, the system comprising:
a finding database which stores one or more clinical findings; and
a mapping device which includes:
a display which displays an interface; and
one or more processors programmed to:
retrieve one or more clinical findings queried from the finding database;
detect one or more paragraph identifiers in a document;
map the one or more clinical findings to the detected one or more paragraph identifiers;
automatically insert the mapped clinical findings into the paragraph identifiers; and displaying
the document with the one or clinical findings inserted into the detected one or more paragraph identifiers.

9. The system according to claim 8, wherein the information objects are free-text strings or multi-modal information objects.

10. The system according to claim 8, wherein the one or more paragraph identifiers are parameterized by a user's credentials and/or a group profile.

11. The system according to claim 8, wherein the one or more processors are programmed to:
display a list of paragraph identifiers for unmapped information objects to the user.

12. The system according to claim 8, wherein the one or more information objects to the detected one or more paragraph identifiers utilizing at least one of: the user profile, medical ontology, patient study information, and automatic organ labeling.

13. A system for inserting structured content into template-based documents, the system comprising:
a finding database which stores one or more clinical findings; and
a mapping device which includes:
a reporting environment engine configured to:
retrieve one or more clinical findings queried from the finding database;
detect one or more paragraph identifiers in a document; and
a personalized finding-to-paragraph mapping engine configured to:
map the one or more clinical findings to the detected one or more paragraph identifiers;
automatically insert the mapped clinical findings into the paragraph identifiers; and
display the document with the one or clinical findings inserted into the detected one or more paragraph identifiers.

14. The system according to claim 13, wherein the information objects are free-text strings or multi-modal information objects.

15. The system according to claim 13, wherein the one or more paragraph identifiers are parameterized by a user's credentials and/or a group profile.

16. The system according to claim 13, wherein the system further includes:
a display to display a list of paragraph identifiers for unmapped information objects to the user.

17. The system according to claim 13, wherein the one or more information objects to the detected one or more paragraph identifiers utilizing at least one of: the user profile, medical ontology, patient study information, and automatic organ labeling.
